(19) United States
(12) Patent Application Publication
(10) Pub. No.: US 2018/0132513 A1
(43) Pub. Date: May 17, 2018

(54) Dough for Manufacture of Baked Snack Chips

(71) Applicant: Frito-Lay Trading Company GmbH, Berne (CH)

(72) Inventor: Khalid Mohmood, Leicester (GB)

(21) Appl. No.: 15/572,647

(22) PCT Filed: May 3, 2016
(86) PCT No.: PCT/EP2016/059853

§ 371 Date: Nov. 8, 2017

(30) Foreign Application Priority Data
May 8, 2015 (GB) 1507922.1

(51) Int. Cl. A23L 19/18; A21D 2/18; A23L 5/10; A23L 29/10; A23P 30/20

(52) U.S. Cl. CPC A23L 19/19; A21D 2/186; A23V 2002/00; A23L 29/10; A23P 30/20; A23L 5/15

(57) ABSTRACT

A dough composition for the manufacture of baked snack chips, the dough composition comprising: a mixture of a solid component and a liquid component, the solid component comprising a dehydrated potato ingredient, and the liquid component is an oil-in-water emulsion comprising a liquid lecithin ingredient, a vegetable oil ingredient and water, wherein the liquid lecithin ingredient comprises lecithin derived from vegetable oil in a vegetable oil carrier, wherein the vegetable oil ingredient comprises or consists of sunflower oil, the lecithin is derived from sunflower oil and the vegetable oil carrier comprises or consists of sunflower oil. There is also disclosed a method of making the dough composition and a method of making snack chips from the dough composition.

### CROSS-REFERENCE TO RELATED APPLICATIONS

This application is a US 371 National Stage Application from PCT/EP2016/059853 filed May 3, 2016, which claimed the priority of Great Britain Application No. 1507922.1 filed May 8, 2015, which has been allowed as of Nov. 8, 2017, the technical disclosures of which are hereby incorporated herein by reference.

This invention relates to a dough composition for the manufacture of baked snack chips, a method of making such a dough composition, and to a method of making baked snack chips from such a dough composition.

There is a general desire among snack food manufacturers, consumers and regulatory authorities for healthier food products. In the snack food industry, this has led to a desire for lower fat products. However, even though there may be a general consumer awareness of the benefits of eating lower fat versions of, or alternatives to, existing snack food products, the consumer generally requires the product to have desirable attributes such as texture and flavour. Even if a snack food product is produced which has high nutritional attributes, unless it also has the texture and flavour required by the consumer, the product would not successfully provide the consumer with an acceptable product to replace previous, less healthy snack food products. The challenge among snack food manufacturers is to produce nutritional or more healthy foods which provide the consumer with an improved taste and sensation experience, i.e. organoleptic properties, or at the very least do not compromise on taste and sensation as compared to the consumer's expectation for the particular product or class of products purchased.

It has been known for a number of years to produce snack chips by baking individual dough sheets. Baking tends to produce a snack food with lower oil content than fried snack chips. Such snack chips may be formed of a potato-based dough to form baked potato chips (or crisps). The dough is typically composed of dry ingredients, such as dehydrated potato flakes, waxy corn starch and sugar, and liquid ingredients, such as water and vegetable oil. It is known to incorporate an emulsifying agent into the dough to bind together the dry and liquid ingredients in order to form a homogeneous dough which can reliably be sheeted and then cut to form the individual dough sheets to be baked. A known emulsifying agent is lecithin, which is rich in phosphatidylcholine and other phosphatides.

It is known to use powdered lecithin in such a dough as the emulsifying agent. The powdered lecithin can readily be incorporated into the dough to provide the required homogeneous dough. However, the use of powdered lecithin provides a problem in that in the imminent future it may be more difficult for snack food manufacturers to source powdered lecithin which has not been derived from a genetically-modified (GM) material. The use of GM powdered lecithin is not acceptable to some snack food manufacturers because of the desire to produce products which are free of genetically-modified (GM) material, since many consumers wish to purchase and consume GM-free products.

Accordingly, there is a need to provide emulsification of a dough for producing baked snack chips which avoids the use of powdered lecithin yet can provide a homogeneous GM-free dough which can provide the resultant baked snack chips, typically potato-based chips, with the desired consumer acceptance, provided by the resultant organoleptic properties and visual properties, on parity with or better than known baked snack chips.

The present invention accordingly provides a dough composition for the manufacture of baked snack chips, the dough composition comprising: a mixture of a solid component and a liquid component, the solid component comprising a dehydrated potato ingredient, and the liquid component is an oil-in-water emulsion comprising a liquid lecithin ingredient, a vegetable oil ingredient and water, wherein the liquid lecithin ingredient comprises a vegetable oil-based lecithin in a vegetable oil carrier, wherein the vegetable oil ingredient comprises or consists of sunflower oil, the lecithin is derived from sunflower oil and the vegetable oil carrier comprises or consists of sunflower oil.

The present invention further provides a method of making a dough composition for the manufacture of baked snack chips, the method comprising the steps of:
a. emulsifying together a liquid lecithin ingredient, a vegetable oil ingredient and water, to form a liquid component in the form of an oil-in-water emulsion, wherein the liquid lecithin ingredient comprises a vegetable oil-based lecithin in a vegetable oil carrier; and
b. mixing the liquid component with a solid component to form a dough composition, the solid component comprising a dehydrated potato ingredient.

The present invention further provides a method of making baked snack chips from a dough composition, the method comprising the steps of:
i. making a dough composition according to the present invention or according to the method of the present invention;
ii. forming the dough composition into a sheet;
iii. cutting the sheet into a plurality of individual sheet pieces; and
iv. baking the individual sheet pieces to form the baked snack chips.

Preferred features are defined in the dependent claims.

The present inventor found that liquid lecithin, which itself is a widely commercially available ingredient, presents problems when being incorporated into a dough, in particular a potato flake-containing dough to be sheeted to form snack chips. The liquid lecithin is difficult to mix into such a dough, and can result in poor dough uniformity and poor sheet formation, with consequential poor texture and organoleptic properties of the resultant baked snack chip.

The present invention is at least partly predicated on the finding by the present inventor that a particular liquid lecithin composition may be emulsified with a compatible vegetable oil and water to form a stable oil-in-water emulsion which can then be incorporated into a dough composition by combining the emulsion with the dry ingredients of the dough. The lecithin-containing oil-in-water emulsion can be uniformly mixed with the dry ingredients to form a homogeneous dough. The resultant dough can readily be sheeted, and the resultant snack chips after baking have a desired texture and organoleptic properties.

In contrast to that finding, the present inventor has also found that if, contrary to the present invention, liquid lecithin is mixed only with vegetable oil, for example sunflower oil, prior to incorporation onto a dough comprising potato flakes for producing snack chips, the lecithin-oil mixture was not uniformly mixed into the dough. The resultant dough could not be readily sheeted and the resultant sheet pieces were not uniform in composition. A similar problem arises if the lecithin and oil are added individually to the dough.

Moreover, it has been found by the present inventor, in accordance with a preferred aspect of the present invention, that if the liquid lecithin composition comprises sunflower oil as the vegetable oil carrier and the lecithin is derived from sunflower oil, and also if the vegetable oil with which the liquid lecithin composition is combined to form the oil-in-water emulsion is sunflower oil, then the an oil-in-water emulsion can readily be formed at ambient temperature and is stable. Furthermore, it has been found by the present inventor that such an oil-in-water emulsion comprising sunflower oil as the sole vegetable oil can be readily mixed with potato flakes to form the dough. In contrast, liquid lecithin compositions based on soya oil, in which the lecithin is derived from soya bean oil and/or which included a soya bean oil carrier, could not readily form a stable oil-in-water emulsion at ambient temperature.

Furthermore, it was found by the present inventor that the incorporation of a stable oil-in-water emulsion as the lecithin containing component into a potato flake dough used to manufacture baked snack chips provided, as found by a statistically validated consumer research test, at least parity liking for the snack chips produced using an oil-in-water emulsion comprising lecithin versus the product produced using powdered lecithin, and similar, or for some attributes improved, texture and organoleptic properties, and reduced fat content, as compared to the use of powdered lecithin. In addition, the cost of using the liquid lecithin is less than the cost of using the powdered lecithin, and so similar or improved properties of the snack chip product can be achieved at a lower production cost.

Embodiments of the present invention will now be described, by way of example only, with reference to the accompanying drawing in which:

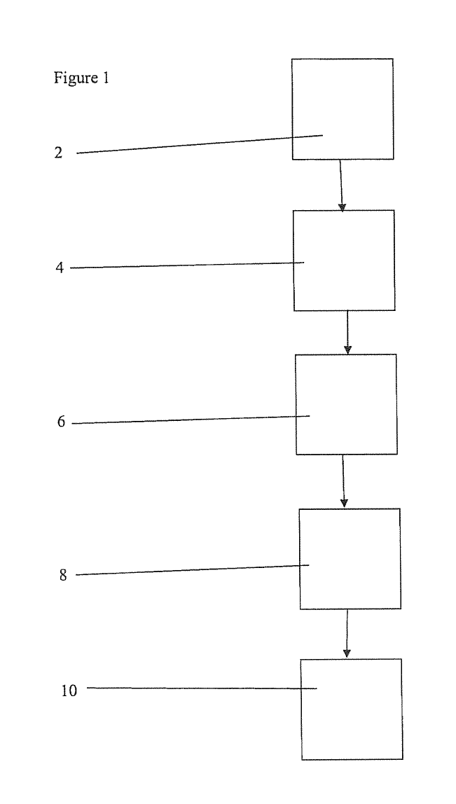

FIG. 1 schematically illustrates a process flow for the manufacture of a baked snack chip in an embodiment of the method of the present invention.

Referring to FIG. 1 which schematically illustrates a process flow for the manufacture of a baked snack chip in an embodiment of the method of the present invention, the method produces a dough composition which is then formed into sheet pieces which are subsequently baked to form the baked snack chips.

In a first step 2 of the method, a liquid lecithin ingredient, a sunflower oil ingredient and water are emulsified together to form a liquid component in the form of an oil-in-water emulsion. This emulsification step is preferably carried out at a temperature of from 10 to 30° C., optionally from 15 to 25° C. The emulsion is formed by homogenizing the water, oil and liquid lecithin with an inline shear mixer with a typical shear rate of 41,500 s⁻¹.

The liquid lecithin ingredient comprises a sunflower-oil based lecithin, which means that the lecithin is derived from sunflower oil, and a sunflower oil carrier, and optionally water. Preferably, the liquid lecithin ingredient comprises from 50 to 100 wt % of the sunflower-oil based lecithin and from 0 to 50 wt % of at least one of sunflower oil and water or a mixture thereof, each wt % being based on the weight of the liquid lecithin ingredient, optionally from 60 to 100 wt % of the sunflower-oil based lecithin and from 0 to 40 wt % of at least one of sunflower oil and water or a mixture thereof, each wt % being based on the weight of the liquid lecithin ingredient.

Preferably, the sunflower-oil ingredient comprises high oleic acid sunflower oil, optionally comprising at least 80 wt % oleic acid.

In a preferred embodiment therefore, the liquid component includes sunflower-oil based lecithin together with sunflower oil both from the carrier and from the sunflower-oil ingredient, and most preferably sunflower oil is the sole vegetable oil present in the dough composition. In other words, preferably both the oil from which the lecithin is derived and the oil in the liquid component are from the same vegetable source, which is most preferably sunflower oil.

Typically, the liquid component comprises from 3 to 6.5 wt % of the liquid lecithin ingredient, from 0.3 to 0.8 wt % of the sunflower oil ingredient and from 92.7 to 96.7 wt % water, each wt % being based on the weight of the liquid component. More typically, the liquid component comprises from 4 to 5.5 wt % of the liquid lecithin ingredient, from 0.45 to 0.65 wt % of the sunflower oil ingredient and from 93.85 to 95.55 wt % water, each wt % being based on the weight of the liquid component.

In a second step 4 of the method, the liquid component is mixed with a solid component, in particular dry ingredients, to form a dough composition. The solid component comprises a dehydrated potato ingredient, typically potato flakes. Preferably, the dehydrated potato ingredient comprises from 50 to 55 wt % of the weight of the dough composition. The mixing to form the dough composition is typically carried out at a temperature of from 20 to 30° C., optionally about 25° C.

The vegetable oil in both the dough and in the lecithin component preferably comprises sunflower oil. The oil in the dough is preferably high oleic sunflower oil conventionally used for manufacturing potato chips. The oil in the dough and/or in the lecithin component may additionally comprise any other vegetable oil, optionally rapeseed oil, for example in an 80:20 wt % ratio of high oleic sunflower oil (HOSO) and rapeseed oil. The oil is employed in the dough provides the required organoleptic properties to the resultant baked snack chip, preferably a baked potato chip.

The solid component may further comprise a starch ingredient, which typically comprises at least one starch selected from potato starch, maize starch and mixtures thereof.

Although the present invention is described with particular reference to potato-containing dough, the method of the invention may be employed to make snack chips comprising flakes or dough of one or more other vegetables, for example root vegetable such as carrot, parsnip, beetroot, sweet potato, etc. or any mixture thereof and/or optionally in combination with potato. The dough may optionally also comprise additional components or additives, such as vegetable pieces, and/or one or more cereals, in flour and/or particulate form.

The mixing to form the dough composition is typically carried out in a continuous dough mixer and the liquid component is added to the solid component in the continuous dough mixer by pouring. Alternatively, the mixing to form the dough composition may be carried out in a batch dough mixer and the liquid component is added to the solid component in the batch dough mixer by pouring.

Alternatively, the liquid component, as an oil-in-water emulsion, may be sprayed onto the dough or applied to the dough as a foam.

The resultant dough composition comprises the mixture of the solid component and the liquid component. The solid component comprises the dehydrated potato ingredient. The liquid component comprises the liquid lecithin ingredient, the sunflower oil ingredient and water. The liquid lecithin ingredient comprises from 1.25 to 1.35 wt % of the dough composition based on the weight of the dough composition. The lecithin comprises from 0.75 to 0.85 wt %, typically about 0.8 wt %, of the dough composition based on the weight of the dough composition.

In a third step 6 of the method, the dough composition is formed into a sheet. The sheet may be formed by extrusion or by rolling. Typically, the sheet has a thickness of from 15 to 25 mm, for example from 18.5 to 19.5 mm. The sheet is progressively thinned by further rolling to a thickness of, for example, 3 to 5 mm, and typically the final roller gap is less than 1 mm, for example from 0.5 to 0.6 mm.

In a fourth step 8 of the method, the sheet of the dough composition is cut into a plurality of individual sheet pieces. These pieces are shaped and dimensioned to correspond to the shape and dimensions of the final snack chips. Any suitable shape and dimensions may be employed. The shape may be regular, for example triangular, or irregular.

Finally, in a fifth step 10 of the method, the individual sheet pieces are baked to form the baked snack chips. The baking may be conducted in any suitable oven and at a cooking temperature and for an appropriate time required to cook the dough step. Such a cooking step, and the cooking parameters, are known to those skilled in the art.

After the baking step, the baked snack chips may be subjected to a seasoning step in which at least one side of the baked snack chips is coated with a topical seasoning. The resultant seasoned snack chips are then packaged, for example in bags, as is well known to those in the snack food art.

The present invention is hereinafter described in greater detail with reference to the following non-limiting Examples.

### EXAMPLE 1

A liquid lecithin ingredient comprising Topcithin SF, available in commerce from Cargill, was provided. This liquid lecithin ingredient comprises a sunflower oil-based lecithin in a sunflower oil carrier, the lecithin comprising about 60 wt % of the liquid lecithin ingredient and the sunflower oil carrier comprising about 40 wt % of the liquid lecithin ingredient. An oil-in-water emulsion was formed by mixing, at an ambient temperature of 15° C. with a 3 stage high shear inline mixer, with a fine grade stator, 4.5 wt % Topcithin SF, 0.5 wt % high oleic sunflower oil (HOSO) and 95 wt % water. The resultant emulsion was stable over an extended storage period of 28 days at an ambient temperature of 15° C.

The emulsion was poured into a batch mixer comprising potato flakes available in commerce from Emsland and the resultant mixture was mixed to form a dough at an ambient temperature of 25° C. The dough comprised 52 wt % potato flakes, 11 wt % corn starch, 3.4 wt % fine sugar, 0.8 wt % lecithin (phosphatide fraction), 0.2 wt % high oleic sunflower oil, 0.5 wt % sunflower oil (from the carrier in the liquid lecithin ingredient), and 32.1 wt % water.

The dough had a uniform homogeneous consistency and sheeted well.

After baking, the snack chips had good appearance, texture and consistency.

### EXAMPLE 2

The emulsion produced in Example 1 was poured into a batch mixer comprising potato flakes as used in Example 1 and the resultant mixture was mixed to form a dough at an ambient temperature of 25° C. The dough comprised the same potato flakes as used in Example 1 and the dough comprised 0.52 wt % lecithin based on the weight of the dough. The liquid lecithin ingredient comprised 0.87 wt % based on the weight of the dough.

The dough was sheeted. After baking, the snack chips had a poor visual appearance, exhibiting blisters or other undesirable non-uniform effects.

### EXAMPLE 3

The emulsion produced in Example 1 was poured into a batch mixer comprising potato flakes as used in Example 1 and the resultant mixture was mixed to form a dough at an ambient temperature of 25° C. The dough comprised the same potato flakes as used in Example 1 and the dough comprised 1.0 wt % lecithin based on the weight of the dough. The liquid lecithin ingredient comprised 1.74 wt % based on the weight of the dough.

The dough was sheeted. After baking, the snack chips had a poor visual appearance, exhibiting blisters or other undesirable non-uniform effects.

### EXAMPLE 4

The emulsion produced in Example 1 was poured into a continuous mixer, with the emulsion entry point being at the upstream end of the mixer, containing potato flakes and the resultant mixture was mixed to form a dough at an ambient temperature of 25° C. The dough comprised potato flakes available in commerce from Emsland and the dough comprised 0.8 wt % lecithin based on the weight of the dough.

The dough had a uniform homogeneous consistency and sheeted well.

The dough was sheeted. After baking, the snack chips had good appearance, texture and consistency.

In different test runs the entry point of the emulsion was varied towards a downstream location of the continuous mixer and it was found that a consistent dough was formed using upstream or downstream entry points.

In different test runs the mixing speed of the continuous mixer was varied between fast and slow speeds, and it was found that a consistent dough was formed using these different mixing speeds.

### COMPARATIVE EXAMPLE 1

Example 4 was repeated but using a conventional powdered lecithin instead of the liquid lecithin component of Example 1. The powered lecithin was added in an amount of 0.8 wt % based on the weight of the dough.

The dough was sheeted. The dough had a reasonably uniform and homogeneous consistency, but the consistency was less uniform and less homogeneous as compared to the dough of Example 4.

After baking, the snack chips had a reasonably good appearance, texture and consistency, but these characteristics were less good than those achieved by the snack chips of Example 4. Also, the snack chips had a higher fat content than the snack chips of Example 4.

### COMPARATIVE EXAMPLE 2

The liquid lecithin ingredient comprising Topcithin SF from Example 1 was pre-mixed with high oleic sunflower oil, and the mixture was poured into a batch mixer comprising potato flakes available in commerce from Emsland. Water was separately added to the batch mixer. No lecithin oil-in-water emulsion was pre-formed. The resultant mixture was mixed to form a dough at an ambient temperature of 25° C. The dough comprised the same composition as Example 1. However, no emulsion was pre-formed as the water was added separately from the liquid lecithin ingredient comprising Topcithin SF.

The resultant dough formed at the ambient temperature of 25° C. was not of uniform homogeneous consistency, and broke up within the mixer.

From the foregoing Examples it can be seen that the liquid lecithin can be readily mixed into a snack chip dough, and can provide good dough uniformity and good sheet formation, with consequential good texture, appearance and organoleptic properties of the resultant baked snack chip, if the liquid lecithin composition is pre-emulsified with a compatible vegetable oil and water to form a stable oil-in-water emulsion which can then be incorporated into the dough composition by combining the emulsion with the dry ingredients of the dough. The lecithin-containing oil-in-water emulsion can be uniformly mixed with the dry ingredients to form a homogeneous dough. The resultant dough can readily be sheeted, and the resultant snack chips after baking have a desired texture and organoleptic properties.

In contrast, if contrary liquid lecithin is mixed only with vegetable oil, for example sunflower oil, prior to incorporation onto a dough comprising potato flakes for producing snack chips, the lecithin-oil mixture was not uniformly mixed into the dough. The resultant dough could not be readily sheeted and the resultant sheet pieces were not uniform in composition.

Moreover, if the liquid lecithin composition comprises sunflower oil as the vegetable oil carrier and the lecithin is derived from sunflower oil, and also if the vegetable oil with which the liquid lecithin composition is combined to form the oil-in-water emulsion is sunflower oil, then the oil-in-water emulsion has the advantage that it can readily be formed at ambient temperature and is stable. Such an oil-in-water emulsion comprising sunflower oil as the sole vegetable oil can be readily mixed with potato flakes to form the dough. In contrast, liquid lecithin compositions based on soya oil, in which the lecithin is derived from soya bean oil and/or which included a soya bean oil carrier, could not readily form a stable oil-in-water emulsion at ambient temperature. The incorporation of a stable oil-in-water emulsion as the lecithin containing component into a potato flake dough used to manufacture baked snack chips provided improved texture and organoleptic properties, and reduced fat content, as compared to the use of powdered lecithin.

1. A method of making a dough composition for the manufacture of baked snack chips, the method comprising the steps of:
i. emulsifying together a liquid lecithin ingredient, a vegetable oil ingredient and water, to form a liquid component in the form of an oil-in-water emulsion, wherein the liquid lecithin ingredient comprises a vegetable oil-based lecithin in a vegetable oil carrier; and
ii. mixing the liquid component with a solid component to form a dough composition, the solid component comprising a dehydrated potato ingredient.

2. The method according to claim 1 wherein the vegetable oil ingredient comprises of sunflower oil.

3. The method according to claim 1 wherein the liquid component comprises from 3 to 6.5 wt % of the liquid lecithin ingredient, from 0.3 to 0.8 wt % of the vegetable oil ingredient and from 92.7 to 96.7 wt % water, each wt % being based on the weight of the liquid component.

4. The method according to claim 3 wherein the liquid component comprises from 4 to 5.5 wt % of the liquid lecithin ingredient, from 0.45 to 0.65 wt % of the vegetable oil ingredient and from 93.85 to 95.55 wt % water, each wt % being based on the weight of the liquid component.

5. The method according to claim 1 wherein the liquid lecithin ingredient comprises from 50 to 100 wt % of lecithin derived from sunflower oil and from 0 to 50 wt % of at least one of sunflower oil and water or a mixture thereof, each wt % being based on the weight of the liquid lecithin ingredient.

6. The method according to claim 5 wherein the liquid lecithin ingredient comprises from 60 to 100 wt % of the lecithin derived from sunflower oil and from 0 to 40 wt % of at least one of sunflower oil and water or a mixture thereof, each wt % being based on the weight of the liquid lecithin ingredient.

7. The method according to claim 1 wherein the sunflower oil ingredient comprises at least 80 wt % oleic acid.

8. The method according to claim 1 wherein the liquid lecithin ingredient comprises from 1.25 to 1.35 wt % of the dough composition based on the weight of the dough composition or the dough composition comprises from 0.75 to 0.85 wt % lecithin based on the weight of the dough composition.

9. The method according to claim 1 wherein the dehydrated potato ingredient comprises potato flakes.

10. The method according to claim 1 wherein the dehydrated potato ingredient comprises from 50 to 55 wt % of the weight of the dough composition.

11. The method according to claim 1 wherein the solid component further comprises a starch ingredient, the starch ingredient comprising at least one starch selected from potato starch, maize starch and mixtures thereof.

12. The method according to claim 1 wherein step a is carried out at a temperature of from 10 to 30° C.

13. The method according to claim 1 wherein step b is carried out at a temperature of from 20 to 30° C.

14. The method according to claim 1 wherein step b is carried out in a continuous dough mixer and the liquid component is added to the solid component in the continuous dough mixer by pouring.

15. The method according to claim 1 wherein step b is carried out in a batch dough mixer and the liquid component is added to the solid component in the batch dough mixer by pouring.

16. A method of making baked snack chips from a dough composition, the method comprising the steps of:
i. making a dough composition according to the method of claim 1;
ii. forming the dough composition into a sheet;
iii. cutting the sheet into a plurality of individual sheet pieces; and
iv. baking the individual sheet pieces to form the baked snack chips.

17. The method according to claim 16 wherein in step ii the sheet is formed by extrusion.

18. The method according to claim 16 wherein in step ii the sheet is formed by rolling.

19. The method according to claim 16 wherein the sheet has a thickness of from 15 to 25 mm, optionally from 18.5 to 19.5 mm.

20. The method according to claim 19 wherein in step ii the sheet is progressively thinned by further rolling to a thickness of 3 to 5 mm.

21. The method according to claim 20 wherein in step ii the sheet is thinned by a final rolling thickness between rollers having a gap of less than 1 mm.
